(19) United States
(12) Patent Application Publication
(10) Pub. No.: US 2019/0302986 A1
(43) Pub. Date: Oct. 3, 2019

(54) OPERATION APPARATUS AND METHOD FOR CONTROLLING THE SAME

(71) Applicant: CANON KABUSHIKI KAISHA, Tokyo (JP)

(72) Inventors: Takayuki Iwasa, Kawasaki-shi (JP); Kenji Ishii, Yokohama-shi (JP)

(21) Appl. No.: 16/357,147

(22) Filed: Mar. 18, 2019

(30) Foreign Application Priority Data
Mar. 30, 2018 (JP) 2018-069294
Mar. 30, 2018 (JP) 2018-069295

(51) Int. Cl. G06F 3/041; G06F 3/01; G06F 3/044; H04N 5/232; H04N 5/225

(52) U.S. Cl. CPC G06F 3/04186; G06F 3/016; H04N 5/2251; G06F 3/0446; H04N 5/23203; G06F 3/0412

(57) ABSTRACT

In a series of touch operations of touching on and releasing from an operation face in an operation apparatus capable of detecting a touch operation, when a first touch operation at less than a first pressure of the touch transits to a second touch operation at the first pressure of the touch or more, a region where a touch operation on the operation face is to be detected is changed.

### BACKGROUND

### Field of the Disclosure

The present disclosure generally relates to an operation apparatus and a method for controlling the same, and particularly to a touchable operation apparatus.

### Description of the Related Art

For example, when a user takes a photograph by a camera as an electronic device, he/she grips (holds) the camera with the right index finger on the release button and the right thumb on the back of the camera in many cases. A conventional camera is generally configured such that operation members such as press button switch or rotation dial for changing the setting are arranged near the positions corresponding to the index finger and the thumb of the right hand gripping the camera. When the setting of the camera is changed while the camera is gripped in this way, the index finger or the thumb of the right hand gripping the camera needs to be temporarily replaced on a different position in order to operate the press button switch or the rotation dial. Thus, the setting is difficult to instantaneously change, and an erroneous operation such as wrong replacement of a finger can be assumed.

On the other hand, a switch or touch panel using a touch sensor is known as an operation member which a user can easily operate with less loads. However, the touch sensor itself does not physically displace unlike press button switches, and thus an erroneous operation can be caused during an operation in a blind way.

Here, for example, Japanese Patent Laid-Open No. 2017-27893 discloses a switch apparatus in which a convex part or a concave part having tilted faces is provided on both sides of the center part of a casing, touch switches are arranged along the shape, and different switch signals are generated on both sides of the center part corresponding to the tilted faces.

Further, Japanese Patent Laid-Open No. 2015-118605 discloses a tactile sensation control unit which changes the magnitude of vibrations depending on a touched area thereby to strengthen vibrations in a situation less sensitive to vibrations such as stylus pen or nail in a configuration of feeding back vibrations depending on a touch operation.

In Japanese Patent Laid-Open No. 2017-27893 disclosed in the above Patent Documents, physical concave/convex is provided to easily recognize the positions of the operation members in the operation unit using a touch sensor different from physical buttons or dials. Further, in Japanese Patent Laid-Open No. 2015-118605, a tactile sensation is fed back thereby to easily recognize whether an operation can be input. However, the techniques in the above Patent Documents enable feedback of the positions of the operation members or the operation inputs to be recognized, but do not describe control after an erroneous operation. That is, for example, also when a user erroneously touches on a touch switch, the touch switch responds to it and a preset signal is output.

### SUMMARY

According to one or more aspects of the present disclosure, a unit is capable of being easily operated and preventing erroneous operations even during an operation in a blind way, for example, in a touchable operation apparatus.

According to one or more aspects of the present disclosure, the present disclosure is characterized by including a detection unit configured to detect a touch operation on an operation face, and a changing unit configured to change a region on the operation face where the touch operation is detected, in which the changing unit changes the region when a first touch operation at less than a first pressure of the touch transits to a second touch operation at the first pressure of the touch or more in a series of touch operations of touching on and releasing from the operation face.

Further features of the present disclosure will become apparent from the following description of exemplary embodiments (with reference to the attached drawings).

### BRIEF DESCRIPTION OF THE DRAWINGS

FIG. 1 is a block diagram illustrating an exemplary system configuration of a camera according to a first embodiment of the present disclosure.

FIGS. 2A and 2B are perspective views illustrating an exemplary entire configuration of the camera according to the first embodiment of the present disclosure.

FIGS. 3A to 3F are diagrams illustrating an exemplary configuration of a touch switch according to the first embodiment of the present disclosure.

FIGS. 4A to 4C are diagrams illustrating an exemplary configuration of the touch switch according to the first embodiment of the present disclosure.

FIG. 5 is a flowchart illustrating how to control detecting an operation of the touch switch according to the first embodiment of the present disclosure.

FIG. 6 is a flowchart illustrating how to control forming shapes of the touch panel according to a second embodiment of the present disclosure.

FIGS. 7A and 7B are diagrams illustrating an exemplary configuration of the camera and shapes of the touch panel according to the second embodiment of the present disclosure.

FIG. 8 is a diagram illustrating an exemplary configuration of the touch panel according to a third embodiment of the present disclosure.

FIG. 9 is a diagram illustrating an exemplary first touch operation according to the third embodiment of the present disclosure.

FIG. 10 is a diagram illustrating an exemplary second touch operation according to the third embodiment of the present disclosure.

FIG. 11 is a diagram illustrating an exemplary third touch operation according to the third embodiment of the present disclosure.

FIG. 12 is a diagram illustrating exemplary touch detectable ranges depending on the first to third touch operations according to the third embodiment of the present disclosure.

FIGS. 13A to 13C are diagrams illustrating exemplary functions of the camera in response to continuous operations on the touch panel according to the third embodiment of the present disclosure.

FIGS. 14A and 14B (FIG. 14) show a flowchart illustrating how to control executing the functions of the camera in response to touch operations with different pressures on the touch panel according to the third embodiment of the present disclosure.

### DESCRIPTION OF THE EMBODIMENTS

Various exemplary embodiments, features, and aspects of the present disclosure will be described below in detail with reference to the accompanying drawings. The description will be made below assuming that an operation apparatus according to the present disclosure is used for a camera as a shooting apparatus, but the operation apparatus according to the present disclosure is not limited to shooting apparatuses, and is applicable to other electronic devices such as, for example, a touch operation panel of a Smartphone, car navigation system, or the like.

### First Embodiment

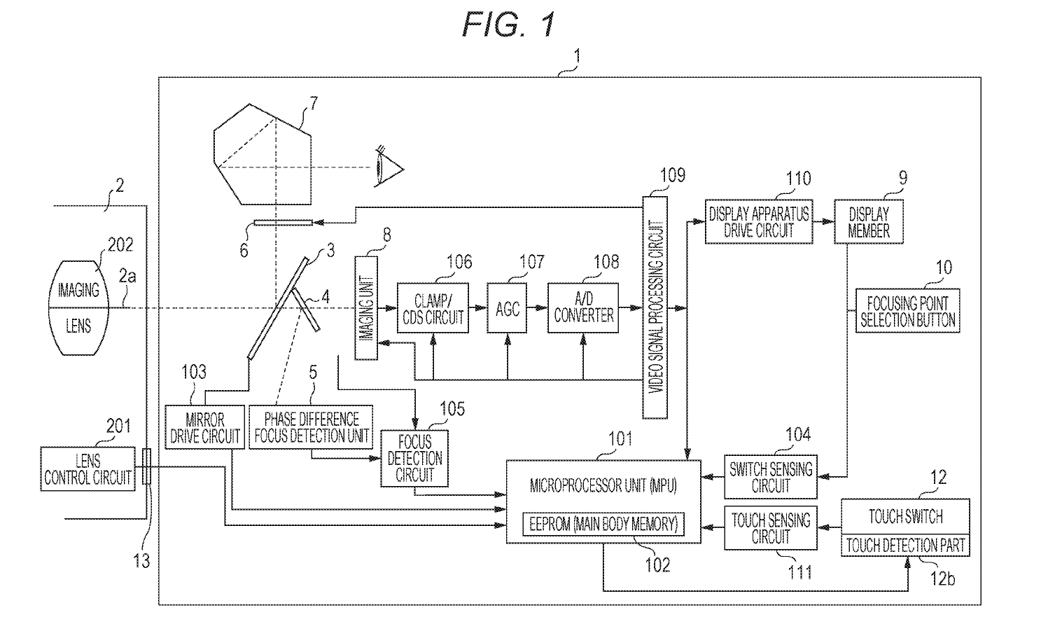

A first embodiment of the present disclosure will be described below with reference to FIGS. 1 to 5. The parts common in FIGS. 1 to 5 are denoted with the same reference numerals.

A system configuration of a camera (shooting apparatus) according to the present embodiment will be first described with reference to FIG. 1. FIG. 1 is a block diagram illustrating an exemplary system configuration of the camera (shooting apparatus) according to the first embodiment of the present disclosure.

A camera 1 as a shooting apparatus is an exemplary electronic device according to the present embodiment. A replaceable lens unit 2 (optical system) is mounted on the camera 1 via a lens mount (not illustrated) to be communicable with the camera 1. A dotted line 2a indicates an imaging optical axis.

The lens unit 2 has a lens control circuit 201 and a group of imaging lenses 202, and forms an object image on an imaging device (not illustrated) inside an imaging unit 8 via the group of imaging lenses 202 and a main mirror 3 while the lens unit 2 is being mounted on the camera 1. The lens unit 2 is not limited to replaceable ones.

The main mirror 3 guides an imaging light beam passing through the group of imaging lenses 202 to a finder unit 7, and transmits and guides part of it to a sub-mirror 4 while held at an angle of 45° relative to the imaging optical axis 2a. The sub-mirror 4 guides the reflected imaging light beam to a phase difference focus detection unit 5, and the phase difference focus detection unit 5 performs focus detection in a phase difference system.

An in-finder display unit 6 can display the shooting conditions such as selected focusing point information, and other setting information of the camera 1, for example, and a user can confirm the information via the display. The finder unit 7 converts and reflects the imaging light beam reflected by the main mirror 3 into and onto an erected normal image. The user can observe the object image via the finder unit 7.

An imaging unit 8 has an imaging device configured to photoelectrically convert an object image, and may have various forms such as CCD (charge-coupled device), CMOS (complementary metal-oxide-semiconductor), and CID (Charge Injection Device) and may employ an imaging device in any form.

A display member 9 may be configured of a thin-film transistor (TFT) liquid crystal panel with about 3.0 inches, for example, and can display a shot image, and a user interface (UI) for operation and setting, for example. Further, the display face of the display member 9 may be used as a touch panel to display the operation members and to receive an individual operation corresponding to an operation member.

A focusing point selection button 10 is an operation member configured to switch focusing point selection modes, and the user presses the focusing point selection button 10 thereby to switch to a mode in which a focusing point can be moved to any position.

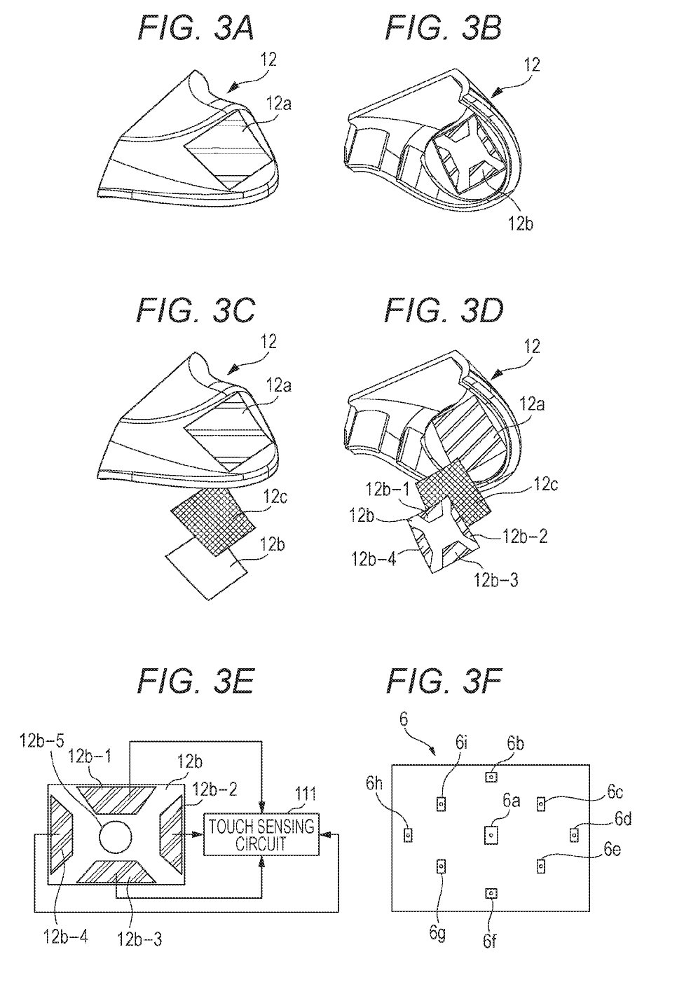

A touch switch 12 is an operation apparatus having a touchable switch part using a touch detection part 12b, and outputs a signal detected by the touch detection part 12b in response to a touch operation. Here, the entire operation apparatus including an exterior member and the switch part is denoted as touch switch 12. How to detect a touch operation will be described below in detail with reference to FIGS. 3A to 3F.

A touch sensing circuit 111 detects a touch operation from the signal output by the touch detection part 12b in response to the touch operation, and transmits a touch operation state to a MPU 101. The MPU 101 can perform a menu operation or an operation of changing a setting value for shooting in response to a touch operation.

A mount contact 13 has a function of transmitting a signal to the MPU 101 described below when connected with the lens unit 2. Thereby, the lens control circuit 201 can make communication with the MPU 101, and can drive the group of imaging lenses 202 in the lens unit 2 thereby to focus on an object.

The microprocessor unit (denoted as “MPU” below) 101, which may include one or more processors, one or more memories, circuitry, or a combination thereof, may be configured of a microcomputer incorporated in the camera 1, may be directed to governing the camera operation control, and may perform various processings and make various instructions on each component. An EEPROM (denoted as main body memory below) 102 can store various camera setting values therein. The MPU 101 is connected with a mirror drive circuit 103, a switch sensing circuit 104, a focusing detection circuit 105, a video signal processing circuit 109, and the touch switch 12. The circuits are assumed to operate under control of the MPU 101. The MPU 101 makes communication with the lens control circuit 201 in the lens unit 2 via the mount contact 13.

The mirror drive circuit 103 is configured of a DC motor and a gear train, for example, and drives the main mirror 3 to be moved to a position where an object image can be observed via the finder and a position which is retracted from an imaging light beam.

The focusing detection circuit 105 makes a focusing detection calculation on the basis of focusing information output by the phase difference focusing detection unit 5 and an imaging signal output by the imaging unit 8. The calculated defocus amount and defocus direction are then communicated to the lens control circuit 201 via the MPU 101 and the mount contact 13.

A clamp/correlated double sampling (CDS) circuit 106 is directed to performing a basic analog processing before analog to digital (A/D) conversion, and can change a clamp level.

An automatic gain control (AGC) 107 is directed to performing a basic analog processing before A/D conversion like the clamp/CDS circuit 106, and can change an AGC basic level. An A/D converter 108 converts an analog output signal of the imaging unit 8 into a digital signal.

The video signal processing circuit 109 performs a gamma/knee processing, a filter processing, and total image processings in hardware on digitalized image data. Image data to be displayed on a monitor from the video signal processing circuit 109 is displayed on the display member 9 via a display apparatus driving circuit 110.

The switch sensing circuit 104 transmits an input signal to the MPU 101 depending on an operation state of each switch.

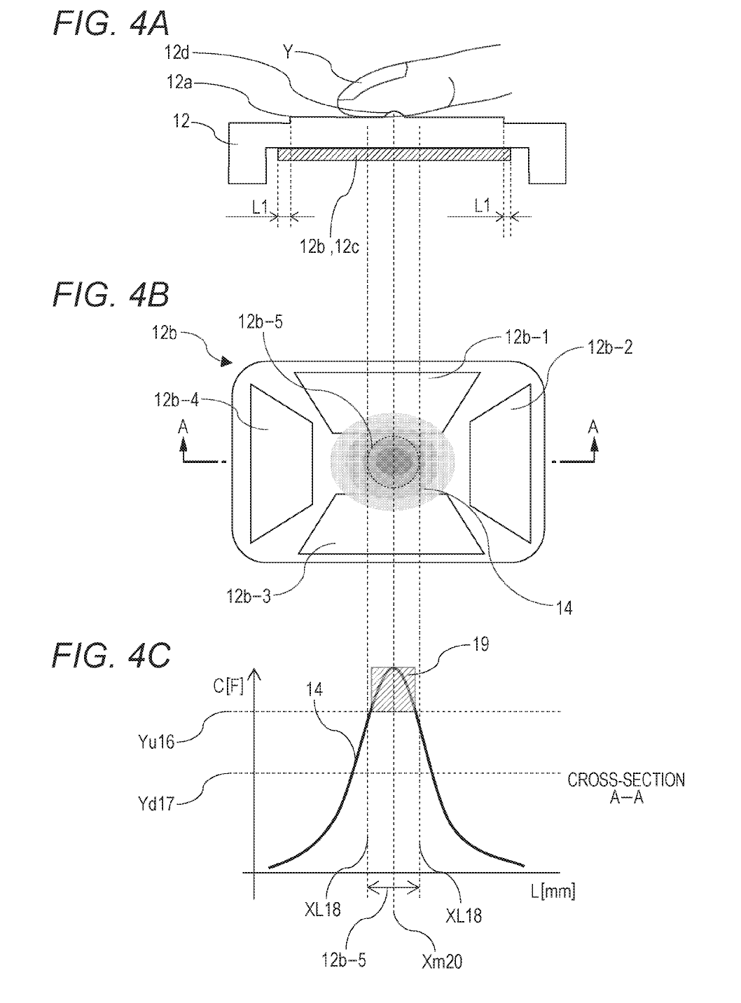

The touch sensing circuit 111 transmits an input signal to the MPU 101 depending on an operation state of the touch switch 12. The touch detection part 12b is an electrode pattern layer or an electrode film of the touch panel, for example, and is adhered to a protective cover to be arranged on the face of the touch switch 12. Its details will be described below with reference to FIGS. 3A to 3F and FIGS. 4A to 4C.

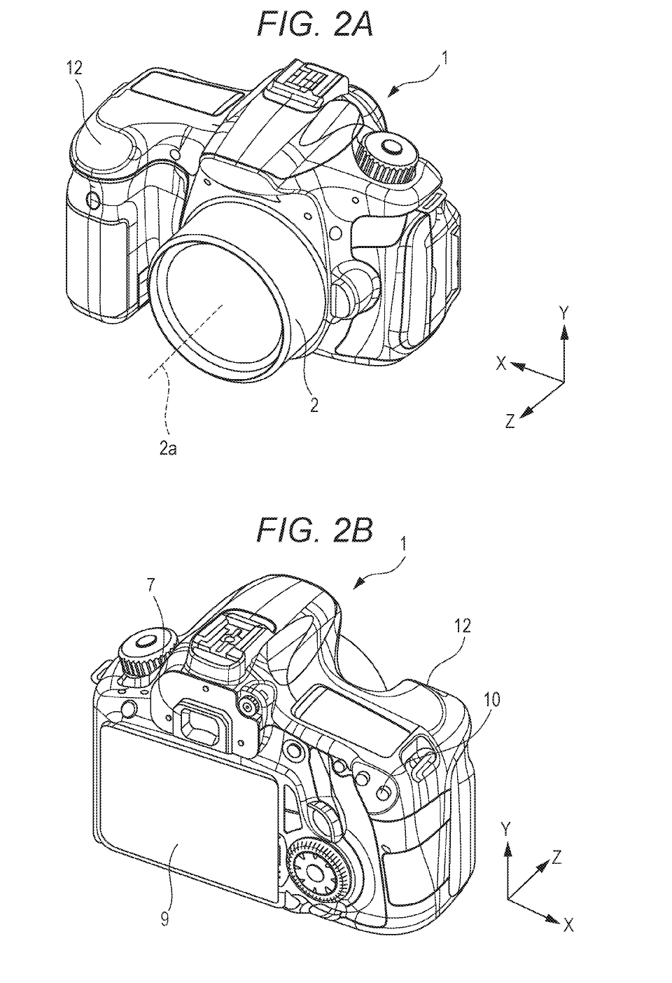

An entire configuration of the camera (shooting apparatus) according to the present embodiment will be described below with reference to FIGS. 2A and 2B. Various switches for controlling the operations of the camera or changing the shooting setting are arranged on the camera 1, for example. FIGS. 2A and 2B are perspective views illustrating an exemplary entire configuration of the camera (shooting apparatus) according to the first embodiment of the present disclosure.

FIG. 2A is an entire perspective view from the front of the camera. The touch switch 12 is arranged near a convex grip by which the user grips the camera, for example, such that the camera 1 can be easily operated while being stably gripped. The touch switch 12 is an exemplary operation apparatus according to the present embodiment, and its details will be described below with reference to FIGS. 3A to 3F. The touch switch 12 illustrated in FIG. 2A is integrally configured with the surface of the casing, and a hole such as mechanical switch does not need to be provided on the casing, thereby improving the dust-proof/drip-proof performance and the degree of freedom of the appearance design.

FIG. 2B is an entire perspective view from the back of the camera. The finder unit 7, the display member 9, the focusing point selection button 10, and the like are arranged on the back of the camera.

A configuration of the touch switch 12 according to the present embodiment will be described below with reference to FIGS. 3A to 3F. FIGS. 3A to 3F are diagrams illustrating an exemplary configuration of the touch switch (operation apparatus) according to the first embodiment of the present disclosure. FIG. 3A is a partial perspective view of the touch switch, FIG. 3B is a partial perspective view of the touch switch viewed from the back, FIG. 3C is a partially-exploded perspective view of the touch switch, and FIG. 3D is a partially-exploded perspective view of the touch switch viewed from the back. The touch switch 12 is a touchable operation member provided on part of the surface of the casing of the camera 1 in FIGS. 3A to 3D.

The touch switch 12 has an operation panel 12a as a region where the user performs a touch operation, and the operation panel 12a is formed in which the operation panel 12a is adhered to the touch detection part 12b via an adhesive agent 12c. The operation panel 12a is arranged at a position where the right index finger is naturally placed when the user grips the camera 1 illustrated in FIGS. 2A and 2B by his/her right hand, thereby improving the operability and providing a camera which prevents a critical moment from being missed.

The touch detection part 12b is a flexible print circuit board (FPC), and is configured of a copper pattern in which a pattern is made of copper foil, a polyimide base member, and a polyimide cover member according to the present embodiment. The pattern of the touch detection part 12b is divided into four upper, lower, right, and left patterns 12b-1, 12b-2, 12b-3, and 12b-4, and is installed on the back of the operation panel 12a by the adhesive agent 12c.

FIG. 3E is an explanatory diagram of how to detect a touch on the touch switch according to an example of the present disclosure. The touch switch 12 can detect the following touch operation patterns and states via the touch sensing circuit 111.
A finger or pen touches on the operation panel (denoted as touch-down below)
A finger or pen is touching on the operation panel (denoted as touch-on below)
A finger or pen is moving on the operation panel while touching on it (denoted as move below)
A finger or pen releases from the operation panel (denoted as touch-up below)
Nothing touches on the operation panel (denoted as touch-off below)

The operations, a touch position coordinate where a finger or pen touches on the operation panel 12a, and a pressure at which a finger or pen touches on the operation panel 12a are given in notification to the touch sensing circuit 111 via the touch detection part 12b and an internal bus (not illustrated). The touch sensing circuit 111 determines which operation has been performed on the touch switch 12 on the basis of the information given in notification.

For move, a moving direction in which a finger or pen moves on the operation panel 12a can be also determined for vertical component and horizontal component on the basis of a change in corresponding position coordinate of the touch detection part 12b. On touch-up from the operation panel 12a at certain move after touch-down, a stroke is assumed to be drawn. When move is detected, it is determined that drag has been performed. An operation of rapidly dragging and finally releasing a finger like flicking is determined as flick operation.

A method for detecting the touch operations will be described below in detail according to the present embodiment. The copper patterns 12b-1 to 12b-4 of the touch detection part 12b are connected to the touch sensing circuit 111 of FIG. 3E, and the touch sensing circuit 111 detects a touch operation, a touch position, and a pressure by the changes in upper, lower, right, and left pattern electrostatic capacitance. Its technique is well known. Further, the touch sensing circuit 111 can determine a balance in the respective electrostatic capacitance values output from the upper, lower, right, and left patterns, and can detect a center area 12b-5. Thus, the user operates the surface (operation face) of the operation panel 12a by his/her finger so that the electrostatic capacitance value of each of the upper, lower, right, and left patterns changes and is detected, thereby detecting an operation direction or pressure of the finger.

Exemplary touch operations on the touch switch 12 will be described below with reference to FIGS. 3E and 3F by way of focusing point selection of the camera 1. FIG. 3F is a diagram for explaining a response when the touch switch according to an example of the present disclosure is attached to the camera 1 and focusing points are operated.

At first, it is assumed that the camera 1 according to the present embodiment includes nine focusing points and a center focusing point 6a is selected, for example. At this time, the nine focusing points 6a to 6i are displayed in a rhombic shape within the in-finder display unit 6, and the focusing point 6a is emphasized and surrounded in a frame such that it is apparently regarded as selected.

Here, in a mode in which a focusing point selection position can be arbitrarily changed, the user touches on the touch switch 12 so that the focusing point selection position can be changed. The user flicks the operation face of the operation panel 12a of the touch switch 12 so that the selected position relatively moves according to the moving amount of the finger. For example, the user moves his/her finger on the operation face of the corresponding operation panel 12a from the center area 12b-5 toward the rightward pattern 12b-2 of the touch detection part 12b thereby to perform a flick operation. In this case, the touch sensing circuit 111 senses the rightward movement of electrostatic capacitance, and the selected focusing point moves from the focusing point 6a to the focusing point 6d.

When the user subsequently flicks his/her finger from the center area 12b-5 toward the leftward pattern 12b-4 twice after the flick operation, the touch sensing circuit 111 senses the leftward movement of electrostatic capacitance twice. Accordingly, the selected focusing point moves from the focusing point 6d toward the focusing point 6a, and then to the focusing point 6h.

When the user subsequently moves his/her finger in the lower right direction between the pattern 12b-2 and the pattern 12b-3 after the flick operation, the touch sensing circuit 111 senses the oblique movement in the lower right direction on the basis of the electrostatic capacitance values detected from the two patterns. Accordingly, the selected focusing point moves from the focusing point 6h to the focusing point 6g. The touch sensing circuit 111 similarly senses and controls a moving direction of an electrostatic capacitance value thereby to operate in the vertical direction.

A configuration of the touch switch 12 and a method for detecting a user touch operation and its electrostatic capacitance will be described below with reference to FIGS. 4A to 4C. FIGS. 4A to 4C are diagrams illustrating an exemplary configuration of the touch switch (operation apparatus) according to the first embodiment of the present disclosure.

FIG. 4A is a cross-section view of the touch switch 12 as an operation apparatus according to the present embodiment. The touch detection part 12b described in FIGS. 3A to 3F is fixed inside the touch switch 12 by the adhesive agent 12c. At this time, the operation panel 12a is desirably installed inward from the end of the touch detection part 12b by a certain distance L1. This configuration is desirable for detecting up to the end of the operation panel 12a by the touch detection part 12b such that the touched end of the operation panel 12a can be detected. Further, the region of the operation panel 12a of the touch switch 12 is desirably changed in its surface shape relative to the surrounding such that the touched end of the operation panel 12a can be determined by finger's feeling when the user operates in a blind way. For example, in FIG. 4A, the operation panel 12a is formed in a convex shape relative to the surrounding. Additionally, the shape of the operation panel 12a may be concave, or may be different in surface coarseness without asperity. Thereby, the user can determine a difference in surface shape between the touch switch 12 and the operation panel 12a only by finger's feeling when operating in a blind way, thereby easily finding the operation panel 12a.

According to the present embodiment, an indicator part 12d configured to indicate a specific position is formed on the operation panel 12a. According to the present embodiment, the indicator part 12d is arranged substantially at the center of the operation panel 12a, and the indicator part 12d has a protruded shape, which is different from the surface shape of the other region of the operation panel 12a. This is an indicator for enabling a specific position (the center region according to the present embodiment) of the operation panel 12a to be determined by a finger Y when the user operates in a blind way. If an indicator by hand feeling is possible, not only the protruded shape illustrated in FIG. 4A but also other convex shape or concave shape may be possible, a tactile sensation may be subjected to feedback control, and any shape or configuration is possible.

FIG. 4B is a diagram in which an electrostatic capacitance detected value 14 detected in the state of FIG. 4A in which the finger Y is approached to the operation panel 12a is overlapped on the front view of the touch detection part 12b. The electrostatic capacitance detected value 14 illustrated in FIG. 4B gradationally indicates a detected value of the electrostatic capacitance value, where the electrostatic capacitance detected value 14 is higher at the dark-colored center part and the electrostatic capacitance detected value 14 is lower at a lighter-colored surrounding. As the area contacting the operation panel 12a is larger or the pressure is higher, the electrostatic capacitance detected value is higher.

FIG. 4C illustrates an electrostatic capacitance value at the cross-section A-A of FIG. 4B. The horizontal axis indicates distance: L [mm], and the vertical axis indicates electrostatic capacitance: C [F]. A broken line Xm 20 indicates a centerline of the indicator part 12d. A threshold Yu16 and a threshold Yd17 are directed for sensing a touch operation (pressure) based on the electrostatic capacitance value, and the threshold Yu16 is higher than the threshold Yd17 (threshold Yu16>threshold Yd17). The threshold Yd17 can detect electrostatic capacitance when the finger Y lightly touches on the surface of the operation panel 12a thereby to perform a touch operation or a slide operation (SW0). The threshold Yu16 can detect electrostatic capacitance when the finger Y reliably touches on the operation panel 12a thereby to perform a touch operation or a slide operation (SW1). For example, a touch operation can be detected when the finger Y presses the operation panel 12a or touches at a pressure of SW0 or more.

A range 19 indicates a region where the electrostatic capacitance detected value 14 of the threshold Yu16 or more is detected in the center area 12b-5. When the electrostatic capacitance of the threshold Yu16 or more is detected in the range 19, it can be determined that the user reliably touches on the indicator part 12d or presses the indicator part 12d by the finger Y (SW1). It is not until a predetermined region (the indicator part 12d) of the operation panel 12a is pressed in the configuration that the entire touch detection part 12b can be enabled. That is, all the touch operations detected in a region other than the indicator part 12d of the operation panel 12a are ignored until the finger Y reliably touches on or presses the indicator part 12d. By doing so, no operation is performed when the user unintentionally touches on the touch switch, and a touch operation is enabled only when the user reliably touches on the predetermined indicator part, thereby preventing erroneous operations in a blind way.

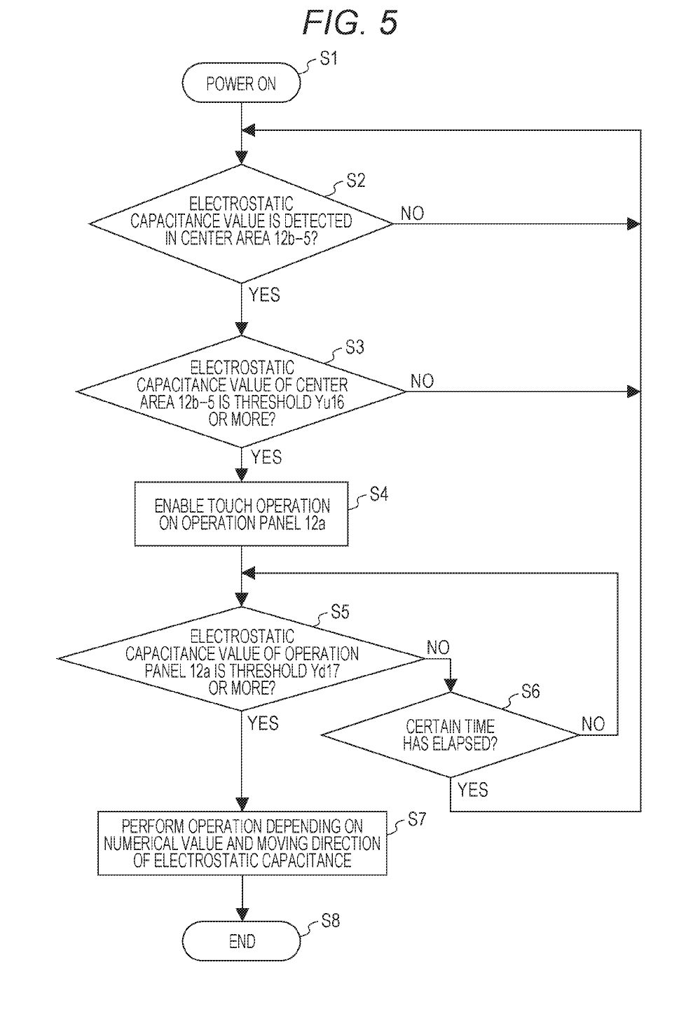

A flow of the operations at this time will be described in detail with reference to FIG. 5. The flowchart of FIG. 5 illustrates a processing procedure performed when the MPU 101 controls each processing block. The MPU 101 develops and executes a program stored in the main body memory 102 thereby to realize the processing procedure.

In step S1, power is supplied to each unit while a power supply switch (not illustrated) provided in the camera 1 is powered ON.

In step S2, a determination is made as to whether electrostatic capacitance is detected in the center area 12b-5 of the touch detection part 12b illustrated in FIGS. 4A to 4C. When the electrostatic capacitance is detected in the center area 12b-5, the processing proceeds to step S3, and when it is not detected, the processing waits until electrostatic capacitance is detected in the center area 12b-5.

In step S3, a determination is made as to whether the electrostatic capacitance detected in the center area 12b-5 of the touch detection part 12b is the threshold Yu16 or more. When the electrostatic capacitance value is less than the threshold Yu16, the processing proceeds to step S2, and when it is the threshold Yu16 or more, the processing proceeds to step S4. At this time, a determination is made as to whether a relationship between the operation panel 12a and the finger Y is that the finger Y is reliably touching on the indicator part 12d (SW1) as illustrated in FIGS. 4A to 4C.

In step S4, the processing enters a state to enable the touch operations detected in all the regions of the touch detection part 12b.

The flow of steps S1 to S4 described herein enables user's unintentional operation to be prevented even if the finger Y unintentionally touches on the operation panel 12a when the user operates the operation panel 12a in a blind way. That is, according to the present embodiment, the indicator part 12d in the center area 12b-5 of the operation panel 12a needs to be reliably touched (SW1) in order for the user to correctly operate the touch switch 12.

A method for operating the operation panel 12a in and subsequent to step S5 will be subsequently described. In step S5, a determination is made as to whether the electrostatic capacitance value detected in the touch detection part 12b is the threshold Yd17 or more. When the electrostatic capacitance value is the threshold Yd17 or more, the processing proceeds to step S7, and when the electrostatic capacitance value is less than the threshold Yd17, the processing proceeds to step S6.

In step S6, a determination is made as to whether the electrostatic capacitance value in the touch detection part 12b is less than the threshold Yd17 for a certain time. When the electrostatic capacitance value is less than the threshold Yd17 for a certain time, the processing proceeds to step S2. When the electrostatic capacitance value exceeds the threshold Yd17 before a certain time elapses, the processing proceeds to step S7. That is, once a touch operation is enabled, a touch operation is continuously enabled when the touch operation (SW0) is performed before a predetermined time elapses. When a touch operation is not detected for a predetermined time, the touch detection part 12b is reset after the predetermined time, and a touch operation in other region is disabled until the center area 12b-5 is operated again.

In step S7, various touch operations can be performed on the basis of the information on the electrostatic capacitance of the threshold Yd17 or more, the moving amount, and the interval. For example, it is possible to receive the operations such as touch operation, push operation, flick operation, swipe operation, tap operation, and slide operation. There can be configured such that a different operation, setting, or item is changed between when the finger moves at a pressure of the threshold Yu16 or more (SW1) and when the finger moves at a pressure of less than the threshold Yu16 and equal to or more the threshold Yd17 (SW0). For example, when a touch operation with SW0 is performed, a focusing point is selected, when a touch operation at a higher pressure than SW0 is performed (SW1), other shooting parameter is changed, and when a touch operation at a much higher pressure is performed (SW2), an object can be shot.

In step S8, the shooting setting is selected and completely performed and the processing proceeds to the shooting standby state. The flowchart ends.

The description has been made herein assuming that the operation (SW1) with electrostatic capacitance of the threshold Yu16 or more is the first operation in the center area 12b-5 in order to enable a touch operation on the operation panel 12a, but the pressure may not be limited to over the threshold Yu16. There may be configured such that other touch operation on the operation panel 12a is enabled irrespective of the pressure when a touch on the center area 12b-5 (SW0) is detected. A configuration of the touch detection part 12b is not limited to the configuration and the method described according to the present embodiment, and may use a projective type or surface type electrostatic capacitance detection system used in an electrostatic capacitance system touch panel, or a pressure-sensitive sensor an output value of which changes depending on a pressure. Further, the touch switch is not limited to the shape described according to the present embodiment, and may be applied to other touchable operation members such as the back liquid crystal of a camera or the surface of a smart device.

As described above, with the touch switch according to the present embodiment, a touch operation in other region is disabled until a predetermined region is touched, thereby reducing user's unintentional and erroneous operations. Further, a shape (indictor) capable of determining the predetermined region in a blind way in order to enable a touch operation is provided, thereby easily operating even when the touch switch cannot be visually confirmed.

### Second Embodiment

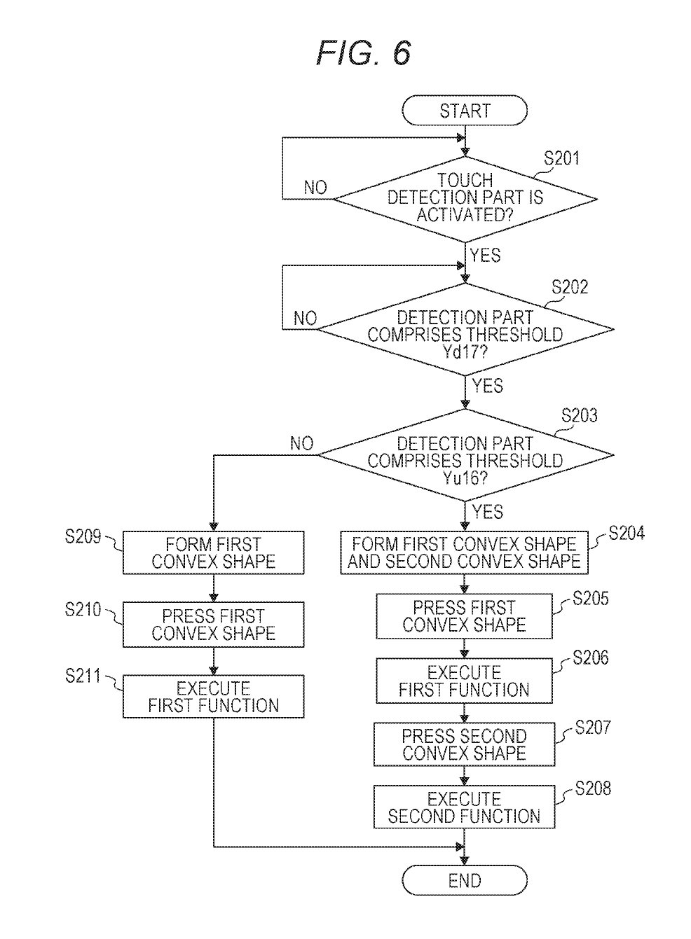

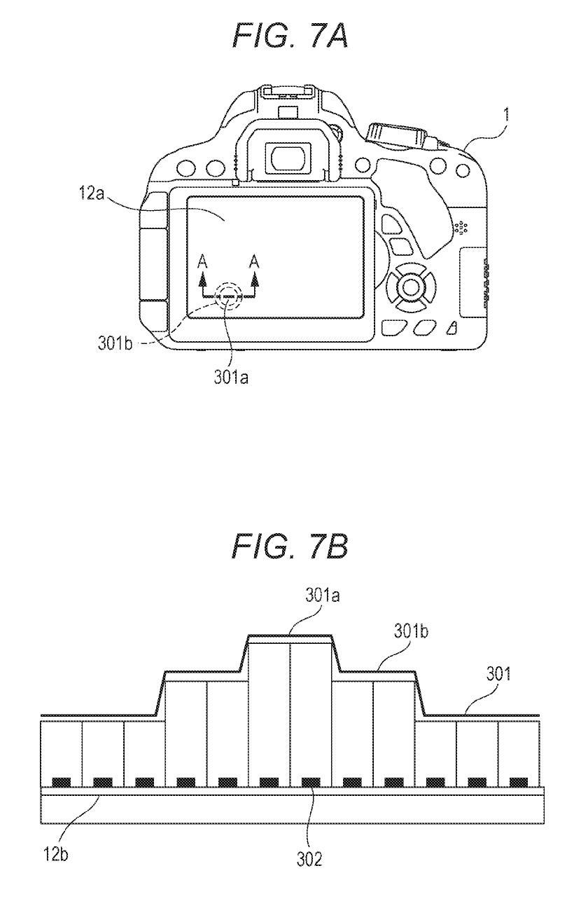

The operation apparatus according to a second embodiment of the present disclosure will be described below with reference to FIGS. 6, 7A and 7B.

FIG. 6 is a flowchart illustrating a flow of the processings performed by the camera 1. The flowchart of FIG. 6 illustrates a processing procedure performed when the MPU 101 controls each processing block. The MPU 101 develops and executes a program stored in the main body memory 102 thereby to realize the processing procedure. It is assumed herein that the processings start when a predetermined application is activated in response to power-ON or user's operation.

At first, in step S201, a determination is made as to whether the function of the touch detection part 12b is activated, when the function is activated, the processing proceeds to step S202, and when it is not activated, the processing waits.

In step S202 or when the touch detection part 12b is activated (YES in step S201), a determination is made as to whether a touch (SW0) with electrostatic capacitance of the threshold Yd17 or more is in the operation range of the touch detection part 12b. When the touch operation with electrostatic capacitance of the threshold Yd17 or more is performed, the processing proceeds to step S203, and when it is not performed, the processing waits until a touch is input.

Then in step S203, a determination is made as to whether a touch operation (SW1) with electrostatic capacitance of the threshold Yu16 or more is performed. When the touch operation (SW1) with electrostatic capacitance of the threshold Yu16 or more is performed, the processing proceeds to step S204, and when the touch operation with electrostatic capacitance of the threshold Yu16 or more is not performed (a touch with SW0 is performed), the processing proceeds to step S209.

When the electrostatic capacitance of the threshold Yu16 is in the operation range of the touch detection part 12b (YES in S203) or when the operation SW1 is performed, the processing proceeds to step S204 to form a first convex shape and a second convex shape. The first convex shape and the second convex shape are different in their areas or heights, for example. The two convex shapes are provided so that the user can easily determine SW1 and SW0 with different pressures, thereby reducing erroneous operations.

The first and second convex shapes will be described herein in detail with reference to FIGS. 7A and 7B. FIGS. 7A and 7B are diagrams illustrating an exemplary configuration of the camera and a shape of the touch panel according to the second embodiment of the present disclosure. FIG. 7A is a back view of the camera (shooting apparatus) according to the second embodiment of the present disclosure, and FIG. 7B is a cross-section view taken along A-A of the operation apparatus (touch panel) of the camera according to the present embodiment. In step S204, a first convex shape 301a and a second convex shape 301b are generated on the touch detection part 12b depending on touch operations on the operation panel 12a.

According to the present embodiment, a concave/convex forming part 301 is configured of a plurality of actuators made of electrolytically elastic material, and has a plurality of electrodes 302. For example, an electric signal is sent to predetermined electrodes 302 via a drive circuit (not illustrated) to change the respective actuators, thereby forming the first convex shape 301a and the second convex shape 301b. The concave/convex amounts of the first convex shape 301a and the second convex shape 301b can be changed by a drive voltage applied to the electrodes 302. The concave/convex forming method is exemplary, and a concave/convex shape may be formed by air or water pressure, and is not limited thereto.

Then in step S205, the user presses the first convex shape 301a to perform a touch operation. At this time, a touch operation (SW0) with electrostatic capacitance of the threshold Yd17 or more is assumed as a valid touch operation.

When the first convex shape 301a is pressed, the processing proceeds to step S206, where the predetermined first function is executable. At this time, the first function can change or adjust the setting or items depending on a flick operation or a slide operation, not only switching ON/OFF the function. When the user presses the first convex shape 301a, the presence of a touch is detected by the touch detection part 12b, and additionally a counter-electromotive force due to the pressed electrodes 302 is detected by the drive circuit, thereby detecting the pressure. When the first convex shape 301a is pressed and a flick operation or slide operation is detected on the basis of touch-on, touch-off, or movement of a touch position, the predetermined first function corresponding to the operation is executable.

Then in step S207, the user further presses the first convex shape 301a and touches on the second convex shape 301b thereby to press the second convex shape 301b. At this time, the touch operation (SW1) with electrostatic capacitance of the threshold Yu16 or more is performed with a higher pressure than in the operation on the first convex shape 301a, thereby pressing the second convex shape 301b.

When the second convex shape 301b is touched, the processing proceeds to step S208, where the predetermined second function different from the first function is executable. At this time, the second function can change or adjust the setting or items depending on a flick operation or a slide operation, not only switching ON/OFF the function. When the second convex shape 301b is pressed and a flick operation or a slide operation is detected on the basis of touch-on, touch-off, or movement of a touch position, the predetermined second function corresponding to the operation on the second convex shape is executable.

On the other hand, in step S203, when the electrostatic capacitance due to the touch does not reach the threshold Yu16, or when the touch operation SW0 is performed, the processing proceeds to step S209, where only the first convex shape 301a is formed. That is, when the touch operation (SW0) at less than a predetermined pressure (the electrostatic capacitance of less than the threshold Yu16) is detected, the two-phase convex shapes are not formed.

Thereafter, in step S209, the user touches on the first convex shape 301a and presses the first convex shape 301a so that the first function is executable. At this time, the first function can change or adjust the setting or items depending on a flick operation or a slide operation, not only switching ON/OFF the function. When the finger releases in the middle in the flowchart, or when the electrostatic capacitance reaches less than a predetermined value, the processing exits the operation flow of the flowchart, and the concave/convex shapes formed on the operation panel are recovered.

The concave/convex shapes are formed by the presence of the threshold Yu16 (SW1) and the threshold Yd17 (SW0), but the convex shapes may be formed by the detected user's touches. For example, the first convex shape 301a and the second convex shape 301b may be changed by an operation range or sensitivity on the touch detection part 12b. Further, for example, when the electrostatic capacitance detected value is low, the first convex shape 301a and the second convex shape 301b may be larger in height/area than the normal ones. Thereby, a reduction in operability by the touch detection part 12b can be restricted even in a low-sensitivity operation environment. When the touch detection part 12b detects a touch in a narrow range such as a stylus pen, a concave shape may be formed within the first convex shape and the second convex shape. Thereby, it is possible to prevent the stylus pen from unintentionally slipping.

As described above, according to the present embodiment, there is configured such that the first convex shape is operated in the touch operation SW0 and is further pressed to perform the touch operation SW1 thereby to operate the second convex shape, and thus the operator can easily grasp the depth direction of the touch operation. The indicator part as in the first embodiment is provided on the touch panel and is implemented in combination with the first embodiment, thereby further improving the operability.

### Third Embodiment

In the above configuration in which a plurality of functions can be continuously executed, when a next function is continuously executed from a position where the first function is executed (its setting is confirmed), an operation range for executing the second function can be lacking depending on where the first function is executed. For example, when the first function is confirmed at an end of the touch panel and a region for executing the second function is to further direct toward the end, the setting cannot be selected. In order to solve the problem, an example in which a touch detection enabled region of the touch panel can be changed depending on a touch operation will be described below according to a third embodiment. The third embodiment will be described assuming that the touch switch 12, the operation panel 12a, and the touch detection part 12b as the operation members described in the first embodiment are assumed as a capacitive touch panel 42 which is operable by user touching on the operation panel.

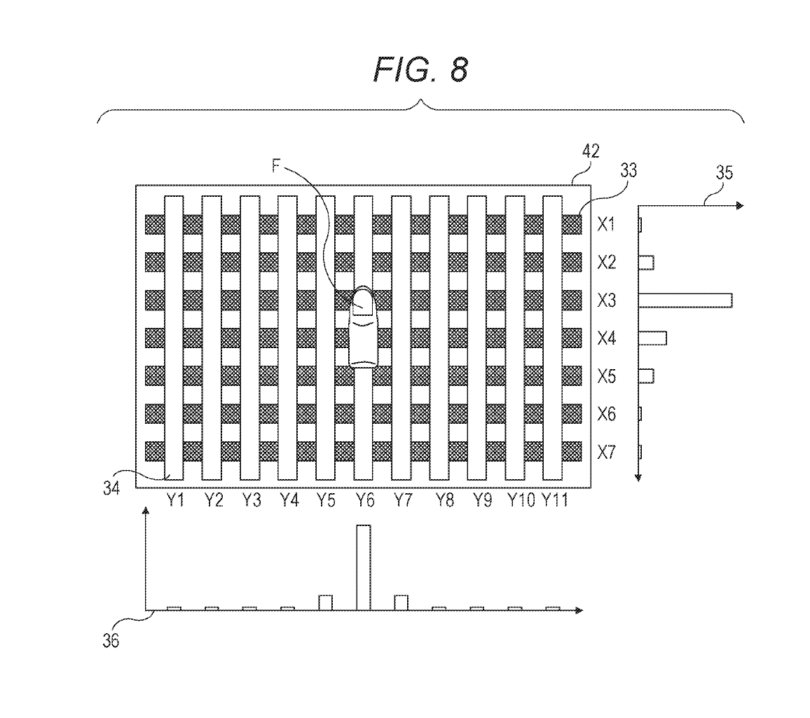

FIG. 8 illustrates an exemplary configuration of the touch panel 42 as an operation apparatus according to the third embodiment of the present disclosure, and illustrates that the user touches on the operation panel of the touch panel 42. The touch panel 42 includes an electrode part to which current or voltage is applied as a component having the similar function to the touch detection part 12b according to the first embodiment. The electrode part is assumed to have a plurality of electrodes arranged in a matrix shape including row electrodes 33 arranged in one direction and column electrodes 34 orthogonal to the row electrodes 33.

The touch panel 42 illustrated in FIG. 8 includes seven row electrodes 33 (electrode X1 to electrode X7) and 11 column electrodes 34 (electrode Y1 to electrode Y11), and applies a drive pulse to desired electrodes in the row electrodes 33 and the column electrodes 34 in response to an instruction from the MPU 101 thereby to accumulate charges therein. The row electrodes 33 and the column electrodes 34 are connected to the touch sensing circuit 111 described in FIGS. 2A and 2B. The touch sensing circuit 111 detects the amounts of charges accumulated in the row electrodes 33 and the column electrodes 34, and compares the change amounts of charges with a predetermined touch detection threshold recorded in the main body memory 102 thereby to determine whether a touch operation has been performed.

FIG. 8 illustrates, in a graph, the electrostatic capacitance values of the row electrodes 33 and the column electrodes 34 as electrostatic capacitance values 35 of the row electrodes and electrostatic capacitance values 36 of the column electrodes, respectively, when the user operates the touch panel 42 by a finger F. The X axis of the graph indicates each electrode (X1 to X7 and Y1 to Y11) and the Y axis indicates accumulated charges (electrostatic capacitance). FIG. 8 illustrates a state in which the finger F touches on an intersection between the row electrode X3 and the column electrode Y6, and at this time, the numerical values of the electrostatic capacitance of X3 and the electrostatic capacitance of Y6 as the electrostatic capacitance value 35 of the row electrode and the electrostatic capacitance value 36 of the column electrode are higher than those of the surrounding electrodes.

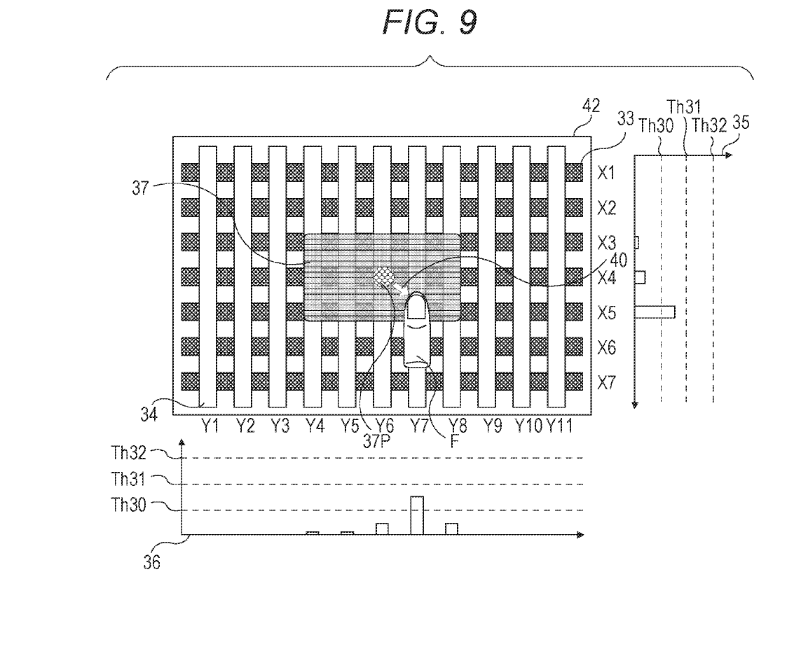

How to control the touch panel 42 when continuously performing the operations of executing a plurality of functions (setting a plurality of different items) by slide operations with different pressures will be described below in detail with reference to FIGS. 9 to 14. The functions are associated functions which are desirable to be continuously set. For example, according to the present embodiment, shooting setting and shooting control of the camera 1 as a shooting apparatus will be described by way of the first touch operation of selecting a focusing point, the second touch operation of selecting an AF mode, and the third touch operation of changing a continuous shooting speed during shooting.

FIG. 9 illustrates an operation of executing the first function (of selecting a focusing point) according to the present embodiment. The initial state is that a drive pulse is applied only to the electrodes (X3 to X5 and Y4 to Y8) within a first touch region 37 in the touch panel 42 and charges are accumulated therein. That is, a touch in the first touch region 37 can be detected, but a touch in the surrounding region outside the first touch region 37, where no charge is accumulated, cannot be detected. Th30, Th31, and Th32 indicate touch detection thresholds recorded in the main body memory 102. A plurality of different functions can be executed or a plurality of different settings can be made depending on in which range the electrostatic capacitance (pressure) is in comparison with the touch detection thresholds Th30, Th31, and Th32, and a combination of a touch position and the moving amount of a touch.

The user touches on the first touch region 37 in the touch panel 42 thereby to execute the first function (of selecting a focusing point). There is illustrated herein a state in which the finger F slides to the coordinate (X5, Y7) after the user touches on a first press position 37P in the first touch region 37. An arrow 40 indicates a moving direction of the finger F, and indicates a state in which the user slides the finger F from the first press position 37P in the first touch region 37 to the coordinate (X5, Y7). Here, the user touches at a pressure exceeding the threshold Th30 and equal to or less than the threshold Th31 thereby to execute the first function.

The first press position 37P indicates substantially the center of the touch panel 42, and the first press position 37P is touched thereby to enable the touch operation according to the present embodiment. Further, for example, the user more strongly presses substantially the center of the touch panel 42 (=the first press position 37P) thereby to disable the touch operation on the touch panel 42 until the pressure exceeds the threshold Th32. With the configuration, unintentional and erroneous operations can be reduced even when the user is operating the touch panel 42 in a blind way.

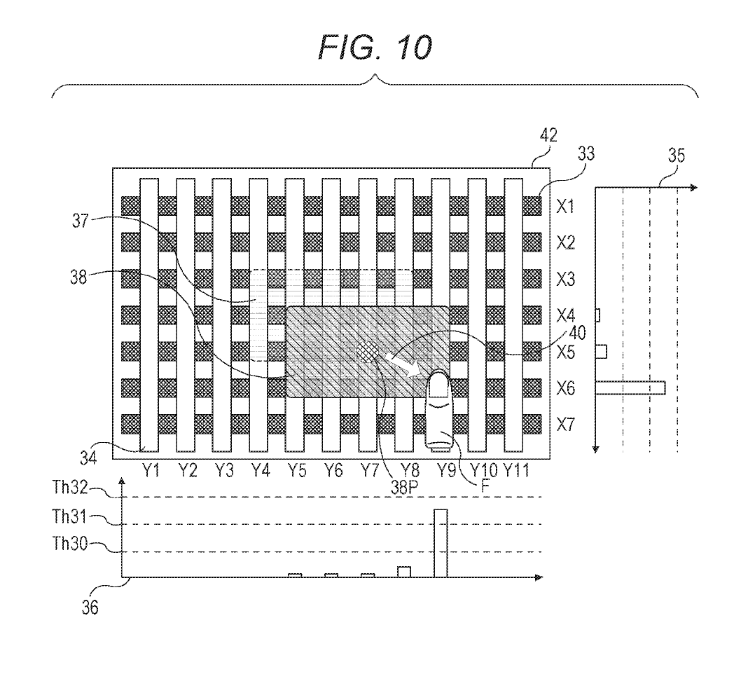

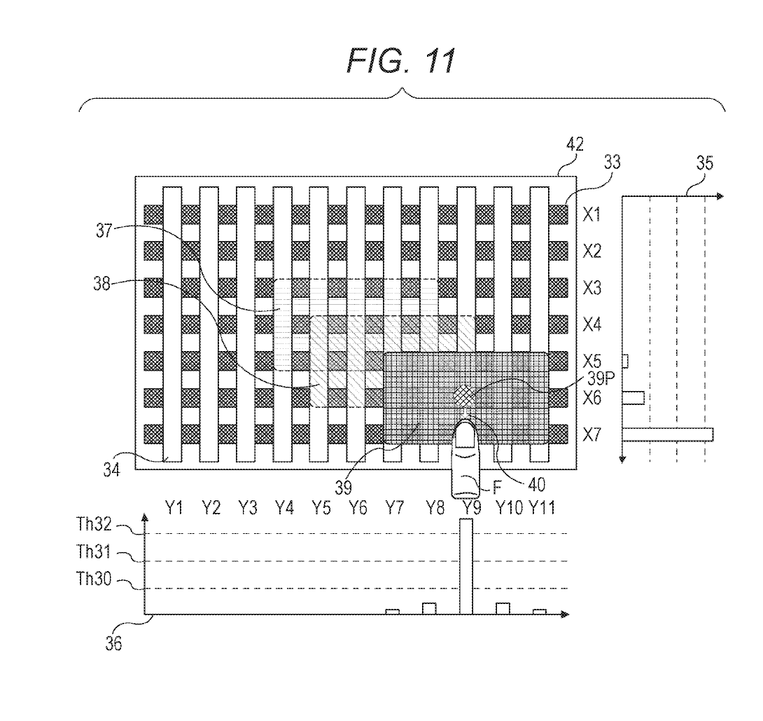

Here, when the coordinate (X5, Y7) is touched at a pressure exceeding the threshold Th31, the touch sensing circuit 111 makes the region about the coordinate (X5, Y7) operable. That is, a drive pulse is applied to the electrodes in the touch region about the coordinate (X5, Y7) thereby to change the touch operation in the range to be detectable. The operation will be described in detail with reference to FIG. 10.

FIG. 10 illustrates an operation of executing the second function (of selecting an AF mode) according to the present embodiment. A second press position 38P indicates a region pressed at a pressure exceeding the threshold Th31 at the coordinate (X5, Y7) in the first touch region 37 in FIG. 9. A touch operation on the second press position 38P at a pressure exceeding the threshold Th31 is given in notification to the MPU 101 via the touch sensing circuit 111. The MPU 101 accordingly applies a drive pulse to the range (X4 to X6 and Y5 to Y9) in the second touch region 38 about the second press position 38P thereby to accumulate charges in the row electrodes 33 and the column electrodes 34. That is, a touch in the second touch region 38 can be detected, but a touch in the surrounding region outside the second touch region 38, where no charge is accumulated, cannot be detected.

FIG. 10 illustrates a state in which the second press position 38P is pressed and the detected touch in the second touch region 38 is accordingly enabled, and then the finger F is slid to the coordinate (X6, Y9). The arrow 40 indicates a direction in which a slide operation is performed while the finger F is pressing the coordinate (X5, Y7) in the second touch region 38. At this time, the user touches at a pressure exceeding the threshold Th31 and equal to or less than the threshold Th32 thereby to execute the second function (of selecting an AF mode according to the present embodiment). Here, when a slide operation is performed in the second touch region 38 in order to execute the second function, the slide operation has to be performed with a stronger pressure than for the first function and a finger moving time during the operation can be longer. It is therefore desirable to further increase a sensitivity of detecting a slide operation in the second touch region 38 than a slide operation in the first touch region 37. By doing so, it is possible to prevent the operation time from being needlessly longer also during a slide operation in the second touch region 38.

When the user touches on the coordinate (X6, Y9) at a pressure exceeding the threshold Th32, the MPU 101 performs the shooting operation of the camera, and makes a third touch region about the coordinate (X6, Y9) operable. That is, a drive pulse is applied to the electrodes in the third touch region about the coordinate (X6, Y9), and changes the touch operation in the range to be detectable. The operation will be described in detail with reference to FIG. 11.

FIG. 11 illustrates an operation of executing the third function (of changing a continuous shooting speed) according to the present embodiment. According to the present embodiment, the MPU 101 gives an instruction to perform the shooting operation of the camera, and then the user operates the third touch region in the touch panel 42 during the shooting operation of the camera thereby to change the continuous shooting speed.

The transition from FIG. 10 to FIG. 11 is substantially similar control to the transition from FIG. 9 to FIG. 10 except different pressure thresholds. In FIG. 10, a touch operation on a third press position 39P at a pressure exceeding the threshold Th32 is given in notification to the MPU 101 via the touch sensing circuit 111. The MPU 101 applies a drive pulse to the range (X5 to X7 and Y7 to Y11) in the third touch region 39 about the third press position 39P, and accumulates charges in the row electrodes 33 and the column electrodes 34. The arrow 40 indicates a direction in which the coordinate (X6, Y9) in the third touch region 39 is slid to the coordinate (X7, Y9) while being pressed by the finger F. At this time, a touch operation is performed at a pressure exceeding the threshold Th31 thereby to change the continuous shooting speed during the shooting operation. Further, at this time, a sensitivity of detecting a touch operation is desirably higher than for a slide operation in the second touch region 38.

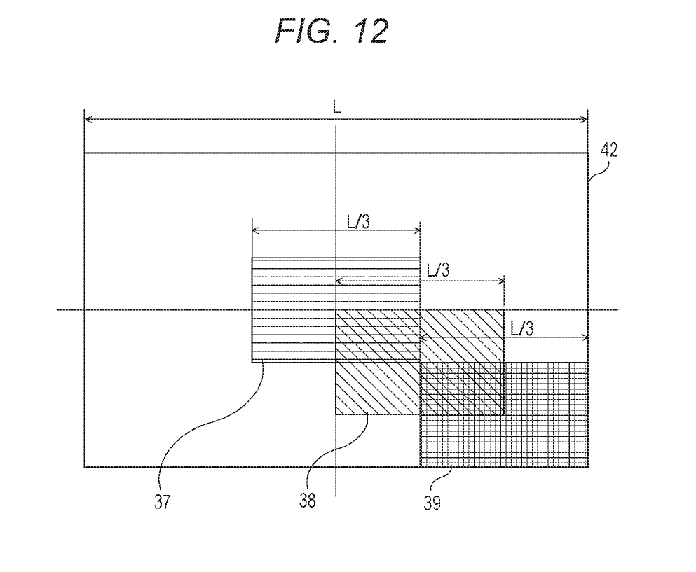

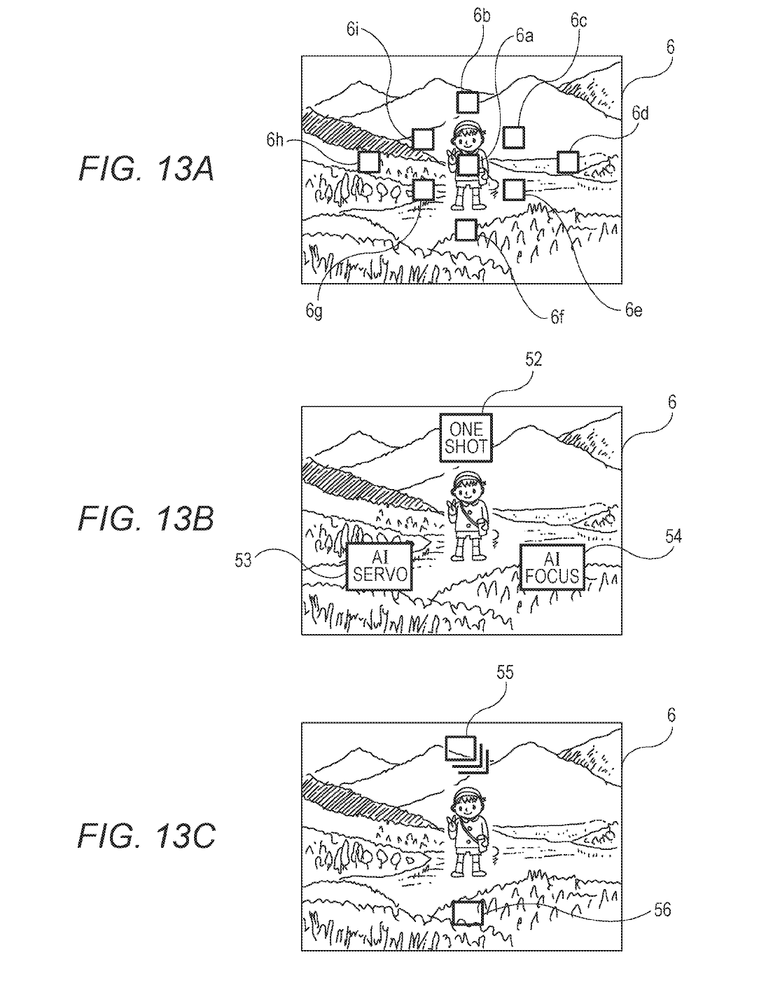

FIG. 12 is a diagram illustrating exemplary ranges of the first to third touch regions described in FIGS. 9 to 11. FIGS. 9 to 11 describe that when the electrostatic capacitance exceeds the thresholds (Th30, Th31, and Th32) recorded in the MPU 101 after a touch region is pressed by the finger F, a new touch region is defined about the pressed position. The third embodiment assumes that the three-phase touch operation regions including the first touch region 37, the second touch region 38, and the third touch region 39 are operable. At this time, a detection range in the touch panel, in which a touch operation is possible in one phase, is “L/3” assuming one long side of the touch panel 42 at “L”. That is, if a touch region with a length of “L/X” in one phase is defined, a detection range in the touch panel in which the touch operations in X phases are possible can be continuously operated in a stepwise manner in one touch panel. Further, it is desirable that the first touch region 37, the second touch region 38, and the third touch region 39 are at substantially the same ratio as the in-finder display unit 6 described below in FIGS. 13A to 13C. By doing so, a desirable operation can be instantaneously performed even in a special situation in which the user operates the release button by his/her index finger in a blind way while viewing the finder as in a camera.

FIGS. 13A to 13C describe exemplary operations of the camera 1 provided with the continuously-operable touch panel 42 described in FIGS. 9 to 12.

In FIG. 13A, focusing points 6a to 6i are displayed in the in-finder display unit 6 and the first touch region 37 in the touch panel 42 is touched and slid thereby to select a desired focusing point.

In FIG. 13B, the autofocus (AF) modes are displayed in the in-finder display unit 6 and the second touch region 38 in the touch panel 42 is slid so that a desired AF mode is selected thereby to switch focusing on an object. ONE SHOT 52 is suitable to shoot a still object, and makes focus adjustment only once. AI SERVO 53 is suitable to shoot an object always changing (moving) in its imaging distance, and continues to focus on an object. In AI FOCUS 54, the camera automatically switches the AF modes from ONE SHOT 52 to AI SERVO 53 depending on a state of an object thereby to focus on the object.

In FIG. 13C, drive modes (continuous shooting speed changing modes) are displayed in the in-finder display unit 6. The third touch region 39 in the touch panel 42 is slid thereby to select a desired drive mode and to switch continuous shooting 55 and single shooting 56. Further, the continuous shooting 55 or the single shooting 56 is selected thereby to linearly vary the continuous shooting speed.

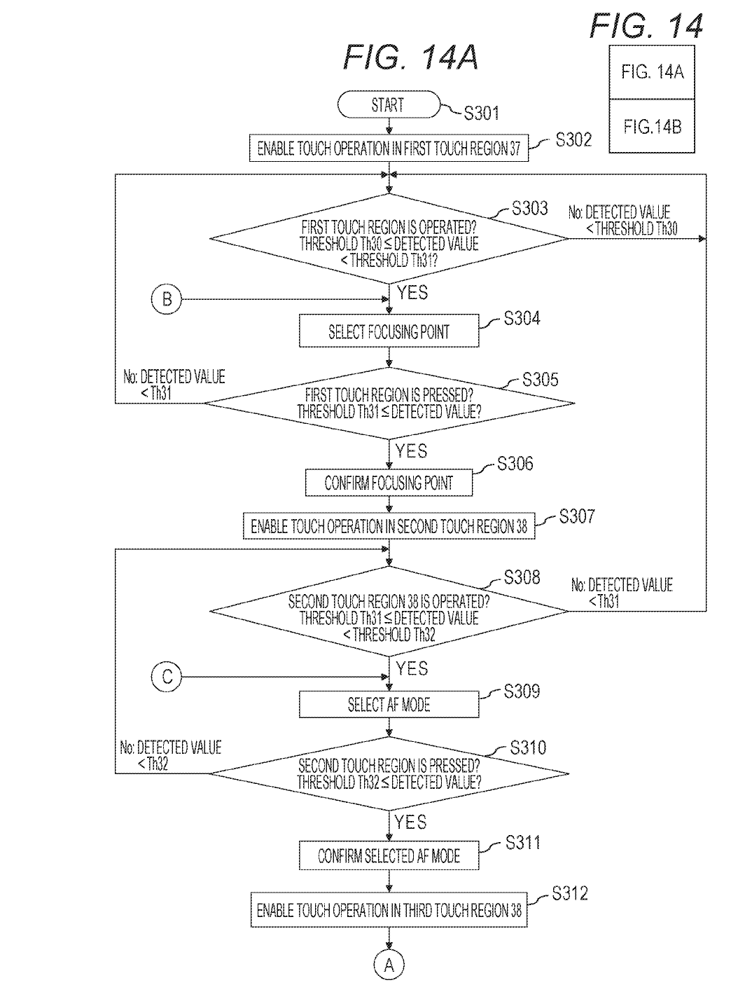

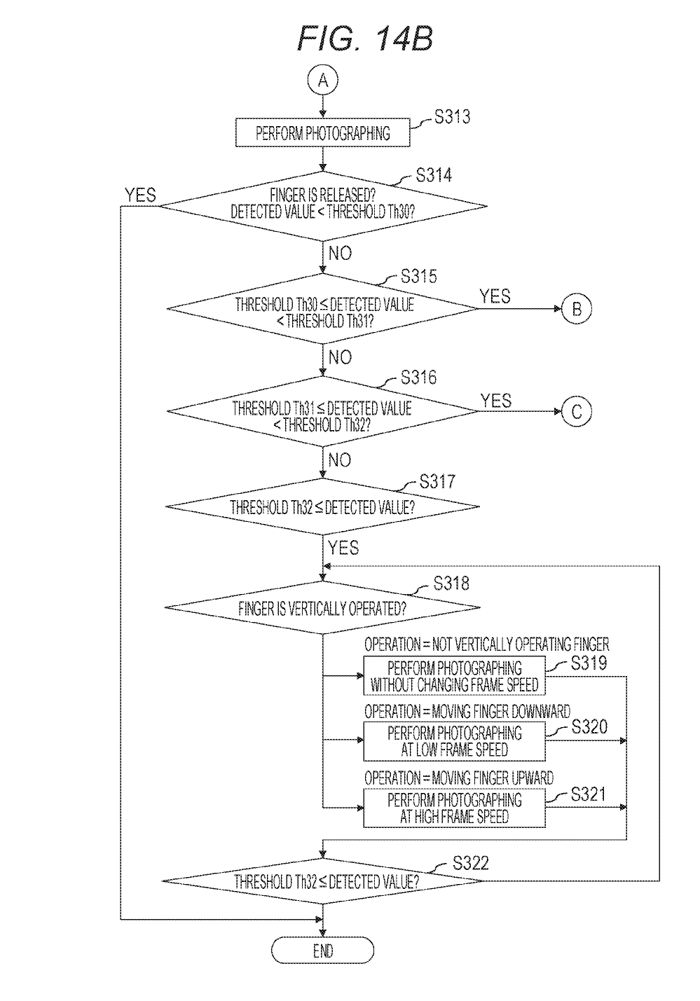

A flow of operations when the user operates the touch panel 42 provided in the camera 1 will be described below with reference to FIG. 14. The flowchart of FIG. 14 illustrates a processing procedure performed when the MPU 101 controls each processing block. The MPU 101 develops and executes a program stored in the main body memory 102 to realize the processing procedure. It is assumed herein that the processings start when a predetermined application is activated in response to power-ON or user's operation.

At first, in step S301, power is supplied to each unit while the power supply switch (not illustrated) provided in the camera 1 is powered ON.

In step S302, a touch operation in the first touch region 37 of FIG. 9 is enabled. The MPU 101 applies a drive pulse to the range (X3 to X5 and Y4 to Y8) in the first touch region 37 and accumulates charges in the row electrodes 33 and the column electrodes 34 thereby to enable the operation in the first touch region 37, and the processing proceeds to step S303.

In step S303, a determination is made as to whether the user touches on the first touch region 37 at a pressure meeting the following Equation (1).

Threshold Th30≤detected value<threshold Th31 Equation (1)

When the detected value of the touch sensing circuit 111 meets Equation (1), the processing proceeds to step S304. When the detected value is less than the threshold Th30, the processing waits until the detected value reaches the threshold Th30 or more. When the touch panel 42 is touched by a finger, the threshold always changes in the order of Th30, Th31, and Th32, and thus the threshold Th31 cannot be first detected with the threshold Th30 skipped.

Then in step S304, the user performs a touch operation meeting step S303 in the first touch region 37 in the touch panel 42 thereby to select a desired focusing point from the focusing points 6a to 6i illustrated in FIG. 13A. Here, in the illustration of FIG. 9, the finger F moves from near the center of the first touch region 37 toward the coordinate (X5, Y7) in the lower right direction. That is, the focusing points in FIG. 13A are selected in the lower right direction from the center, and thus the user finally selects the focusing point 6e (the processing proceeds to step S305).

In step S305, a determination is made as to whether a touch operation is at a pressure detected value of the threshold Th31 or more. When a focusing point is selected and pressed and its detected value is the threshold Th31 or more, the user is assumed to have confirmed the focusing point, and the processing proceeds to step S306. When the detected value is less than the threshold Th31, the user is assumed to be selecting a focusing point, and the processing returns to step S303 to continue the focusing point selection operation. When the finger is released from the operation panel, the processing waits until a touch operation is detected.

In step S306, the focusing point (focusing point 6e illustrated in FIG. 13A) selected by the user in step S305 is confirmed and given in notification to the MPU 101 via the touch sensing circuit 111. The MPU 101 holds the confirmed focusing point in the main body memory 102, and proceeds to step S307.

Then in step S307, the touch operation in the second touch region 38 in FIG. 10 is enabled about the touch position where the focusing point is confirmed in step S306. That is, the MPU 101 applies a drive pulse to the electrodes in the range (X4 to X6 and Y5 to Y9) in the second touch region 38 thereby to make the touch operation detectable. The processing proceeds to step S308.

In step S308, a determination is made as to whether the user touches on the second touch region 38 at a pressure meeting the following Equation (2).

Threshold Th31≤detected value<threshold Th32 Equation (2)

When the detected value of the touch sensing circuit 111 meets Equation (2), the processing proceeds to step S309. When the detected value is less than the threshold Th31, the processing returns to step S303.

In step S309, a desired AF mode is selected from the AF modes illustrated in FIG. 13B depending on a touch operation meeting step S308. Here, the finger F is moved from near the center of the second touch region 38 to the coordinate (X6, Y9) in the lower right direction in FIG. 9. That is, the AF modes are selected in the lower right direction from the center of the AF mode selection screen displayed in FIG. 13B, and the AI FOCUS 54 displayed at the lower right is finally selected (the processing proceeds to step S310).

In step S310, a determination is made as to whether a touch operation is performed at a pressure detected value meeting the following Equation (3).

Threshold Th32≤detected value Equation (3)

When the detected value meets Equation (3), the user is assumed to have confirmed the AF mode, and the processing proceeds to step S311. When the detected value is less than the threshold Th32, the user is assumed to be selecting an AF mode, and the processing returns to step S308 to continue to control AF mode selection.

In step S311, the AF mode (the AI FOCUS 54 illustrated in FIG. 13B) selected depending on the user operation in step S310 is confirmed and given in notification to the MPU 101 via the touch sensing circuit 111. The MPU 101 holds the confirmed AF mode in the main body memory 102, and proceeds to step S312.

In step S312, the operation in the third touch region 39 illustrated in FIG. 11 is enabled about the touch position where the AF mode is confirmed in step S311. That is, the MPU 101 applies a drive pulse to the electrodes in the range (X5 to X7 and Y7 to Y11) in the third touch region 39 thereby to make the touch operation detectable. The processing proceeds to step S313.

In step S313, shooting is performed under the shooting setting conditions saved in the MPU 101. Here, the focusing operation is performed in the AI FOCUS mode confirmed in step S311 at the focusing point 6e confirmed in step S306 thereby to perform shooting.

Subsequently in step S314, a determination is made as to whether the user has released the finger F from the touch panel 42. When the user has released the finger F from the touch panel 42 and the detected value meets the following Equation (4), the shooting operation ends.

Detected value<threshold Th30 Equation (4)

When the user has not released the finger F from the touch panel 42, the processing proceeds to step S315. A processing by the MPU 101 is different depending on a touch detected value (pressure).

In step 315, a determination is made as to whether the touch detected value is in the range of Equation (1). When the detected value meets Equation (1), the processing proceeds to (A) and returns to focusing point selection in step S304. When the detected value does not meet, the processing proceeds to step S316.

In step S316, a determination is made as to whether the touch detected value is in the range of Equation (2). When the detected value meets Equation (2), the processing proceeds to (B) and returns to AF mode selection in step S309. When the detected value does not meet, the processing proceeds to step S317.

In step S317, a determination is made as to whether the touch detected value is in the range of Equation (3). When the detected value meets Equation (3) or when the touch operation is being continuously performed from step S313 at a predetermined pressure or more, the processing proceeds to step S318.

Subsequently in step S318, a determination is made as to whether the finger F has vertically operated in the third touch region 39 during the touch operation at the pressure meeting step S317.

When the finger F has not vertically operated, the processing proceeds to step S319 to perform shooting under the preset shooting conditions. Continuous shooting is performed at the preset continuous shooting speed.

When the finger F has downward operated, the processing proceeds to step S320 to perform an interruption processing of decreasing the frame speed (continuous shooting speed) during the shooting. Here, the interruption processing is performed during the shooting and the continuous shooting speed in the shooting conditions set in the MPU 101 is lowered thereby to perform the shooting.

When the finger F has upward operated, the processing proceeds to step S321. In step S321, the interruption processing of increasing the frame speed (continuous shooting speed) is performed during the shooting. Here, the interruption processing is performed during the shooting and the continuous shooting speed in the shooting conditions set in the MPU 101 is increased thereby to perform the shooting.

In step S322, a determination is made as to whether the touch detected value is in the range of Equation (3). When the touch detected value continuously meets Equation (3), the processing returns to step S318 to continue the shooting while setting the continuous shooting speed depending on a finger (touch position) moving operation. When the touch detected value does not meet Equation (3), the user has released the finger (or the pressure of the touch operation has been lowered), and thus the shooting ends.

When the operation of releasing the finger in the middle is performed in the flowchart, the processing exits the operation flow of the flowchart.

As described above, according to the third embodiment, there is configured such that the operability of the touch panel can be improved and charges are accumulated only in the operation region thereby to enable the touch operation, thereby saving power.

According to the present embodiment, a predetermined position such as the center of the touch panel is touched thereby to enable the touch operation in the initial state, but the first touch region may be set about a first-touched position irrespective of a touch position. Further, the present embodiment has been described assuming that the three different functions are executed depending on three-phase pressure changes, but is not limited thereto. Two-phase continuous functions may be executed, and pressure thresholds and touch regions may be more finely set thereby to execute four or more different functions.

The units described throughout the present disclosure are exemplary and/or preferable modules for implementing processes described in the present disclosure. The term “unit”, as used herein, may generally refer to firmware, software, hardware, or other component, such as circuitry or the like, or any combination thereof, that is used to effectuate a purpose. The modules can be hardware units (such as circuitry, firmware, a field programmable gate array, a digital signal processor, an application specific integrated circuit, or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

The preferred embodiments of the present disclosure have been described above, but the present disclosure is not limited to the embodiments, and may be modified and improved to be adapted as needed within the scope of the technical spirit. For example, the camera described as a shooting apparatus according to the above embodiments can be applied to digital still cameras or digital video cameras. Further, an arrangement of the operation apparatus is not limited to those in the present disclosure, and can be applied to touchable operation members such as the back liquid crystal of a camera or the display face of a smart device. For example, it is particularly effective for an operation apparatus when a blind operation may occur, such as touch operation in a camera or car navigation system. Additionally, any material, shape, dimension, number, and arrangement position of each component in the above embodiments, which can attain the present disclosure, are possible and are not limited.

A program stored in a memory in a computer is operated so that each unit configuring the shooting apparatus and each step in the shooting apparatus control method according to the present embodiments can be realized. The computer program and a computer readable recording medium recording the program therein are included in the present disclosure. They can be realized also in a circuit (such as an application specific integrated circuit (ASIC)) realizing one or more functions.

According to the present disclosure, it is possible to provide a unit capable of being easily operated and preventing erroneous operations even when an operation is performed in a blind way, for example, in a touchable operation apparatus.

### Other Embodiments

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC or the like)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., central processing unit (CPU), micro processing unit (MPU), or the like), and may include a network of separate computers or separate processors to read out and execute the computer executable instructions. The computer executable instructions may be provided to the computerized configuration(s), for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-069294, filed Mar. 30, 2018, and No. 2018-069295, filled Mar. 30, 2018, which are hereby incorporated by reference herein in their entirety.

What is claimed is:

1. An operation apparatus comprising:
a detection unit configured to detect a touch operation on an operation face;
an indicator part on the operation face having a different surface shape from another region of the operation face; and
a processing unit configured to perform a specific processing depending on the detected touch operation,
wherein the processing unit does not perform the specific processing even when a touch operation is performed in the other region until a touch operation on the indicator part is detected, and performs the specific processing depending on a touch operation in the other region after a touch operation on the indicator part is detected.

2. The operation apparatus according to claim 1,
wherein when a touch operation is not detected for a predetermined time or more after a touch operation on the indicator part is detected, the processing unit does not perform the specific processing even when a touch operation is performed in the other region until a touch operation on the indicator part is detected.

3. The operation apparatus according to claim 2,
wherein the processing unit continuously performs the specific processing depending on a touch operation while the touch operation is detected at intervals within the predetermined time after a touch operation on the indicator part is detected.

4. The operation apparatus according to claim 1,
wherein the indicator part has a protruded shape or a concave shape.

5. The operation apparatus according to claim 1,
wherein the operation face is not provided with a display part associated with a touch operation.

6. The operation apparatus according to claim 1,
wherein the processing unit performs a first specific processing depending on the touch operation when the detected touch operation is at a predetermined pressure or more, and performs a second specific processing different from the first specific processing depending on the touch operation when the touch operation is at less than the predetermined pressure.

7. The operation apparatus according to claim 6,
wherein the first specific processing and the second specific processing are associated functions set in continuous operations.

8. The operation apparatus according to claim 6,
wherein the processing unit performs a third specific processing depending on a touch operation when the touch operation is at a second predetermined pressure higher than the predetermined pressure.

9. The operation apparatus according to claim 6, further comprising:
an imaging unit configured to capture an image of an object,
wherein the processing unit can perform the first specific processing of selecting a focusing point depending on a touch operation.

10. The operation apparatus according to claim 6,
wherein the processing unit performs the second specific processing of giving an instruction to prepare shooting.

11. The operation apparatus according to claim 10,
wherein the processing unit can change a shooting parameter for exposure or white balance depending on a touch operation when a touch position is moved during the shooting preparation.

12. The operation apparatus according to claim 10,
wherein the processing unit performs the third specific processing of giving an instruction to shoot.

13. The operation apparatus according to claim 12,
wherein the processing unit can change a continuous shooting speed depending on a touch operation when a touch position is moved during the shooting processing.

14. The operation apparatus according to claim 6, further comprising:
a changing unit configured to change a detection region on the operation face where a touch operation on the operation face is detected,
wherein the changing unit assumes a surrounding region of the indicator part as the detection region after a touch operation on the indicator part is detected, and changes the detection region depending on a touch position when a touch operation is at the predetermined pressure or more.

15. The operation apparatus according to claim 14,
wherein the changing unit changes the detection region to set, as a center, a touch position when the touch operation is at the predetermined pressure or more.

16. The operation apparatus according to claim 14,
wherein when one side of the operation face is assumed at L and touch operations with X-phase thresholds are performed, the changing unit changes the detection region to set one side of the region at a length of L/X.

17. An operation apparatus comprising:
a detection unit configured to detect a touch operation on an operation face;
an indicator part on the operation face;
a feedback unit configured to feed back a touch operation on the indicator part by a tactile sensation; and
a processing unit configured to perform a specific processing depending on the detected touch operation,
wherein the processing unit does not perform the specific processing even when a touch operation is performed in a region other than the indicator part until a touch operation on the indicator part is detected, and performs the specific processing depending on a touch operation in the other region after a touch operation on the indicator part is detected.

18. The operation apparatus according to claim 17,
wherein when a touch operation is not detected for a predetermined time or more after a touch operation on the indicator part is detected, the processing unit does not perform the specific processing even when a touch operation is performed in the other region until a touch operation on the indicator part is detected next.

19. The operation apparatus according to claim 18,
wherein the processing unit continuously performs the specific processing depending on a touch operation while the touch operation is detected at intervals within the predetermined time after a touch operation on the indicator part is detected.

20. The operation apparatus according to claim 17,
wherein the feedback unit generates a tactile sensation when the touch operation on the indicator part is detected.
